(19) United States
(12) Patent Application Publication
(10) Pub. No.: US 2006/0222198 A1
(43) Pub. Date: Oct. 5, 2006

(54) Speaker with elastic fixing device

(76) Inventor: Ping-Yu Lee, Taoyuan (TW)

Correspondence Address: Ping-Yu Lee, 9F., No. 37, Dongsing Road, Xinyi District, Taipei City, 110, TW

(21) Appl. No.: 11/097,803

(22) Filed: Apr. 4, 2005

(51) Int. Cl. H04R 1/02

(52) U.S. Cl. 381/388

(57) ABSTRACT

A speaker includes a cabinet having a first and a second stopper extended from rear and front edges, respectively, of one side thereof to define a clamping space between the two stoppers. An elastic fixing device is mounted inside the first stopper to normally elastically project forward from the first stopper. When the cabinet is approached to an electronic apparatus, such as a screen of a notebook computer, for a lateral side of the screen to move into the clamping space, the elastic fixing device is adapted to firmly push the screen against the second stopper, so that the whole cabinet is firmly assembled to the lateral side of the screen to orient toward a user to produce stereo and high fidelity sound.

### FIELD OF THE INVENTION

The present invention relates to a speaker, and more particularly to a speaker with elastic fixing device for externally assembling to a lateral side of a computer screen to produce stereo and high fidelity sound.

### BACKGROUND OF THE INVENTION

Most currently available notebook computers include only one built-in speaker, which is located inside the computer case with sound apertures formed on a panel of the computer keyboard to transmit the produced sound. Since notebook computers all have very small volume and thickness, there is only very limited space in the computer case for a relatively small speaker. The small-size speaker provides poor sound effect, and the sound apertures provided at one corner of the keyboard fail to produce stereo sound.

### SUMMARY OF THE INVENTION

A primary object of the present invention is to provide a speaker with elastic fixing device that could be conveniently externally assembled to an electronic apparatus, such as one lateral side of a screen of any type notebook computer, so as to provide stereo and high fidelity sound effect.

To achieve the above and other objects, the speaker according to the present invention includes a cabinet having a first and a second stopper extended from rear and front edges, respectively, of one side thereof to define a clamping space between the two stoppers. An elastic fixing device is mounted inside the first stopper to normally elastically project forward from the first stopper. When the cabinet is approached to an electronic apparatus, such as a screen of a notebook computer, for a lateral side of the screen to move into the clamping space, the elastic fixing device is adapted to firmly push the screen against the second stopper, so that the whole speaker is firmly assembled to the lateral side of the screen to orient toward a user to produce stereo and high fidelity sound.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of a speaker with elastic fixing device according to an embodiment of the present invention;

FIG. 2 is a fragmentary and enlarged sectional view showing the assembling of the speaker of FIG. 1 to a screen of a computer;

FIG. 3 is a perspective view showing a notebook computer with two speakers of the present invention assembled to two lateral sides of the screen thereof;

FIG. 4 is an assembled perspective view of a speaker with elastic fixing device according to another embodiment of the present invention;

FIG. 5 is an enlarged sectional view of the elastic fixing device included in the speaker of FIG. 4; and

FIG. 6 is a fragmentary and enlarged sectional view showing the assembling of the speaker of FIG. 4 to a screen of a computer.

### DETAILED DESCRIPTION OF THE PREFERRED EMBODIMENTS

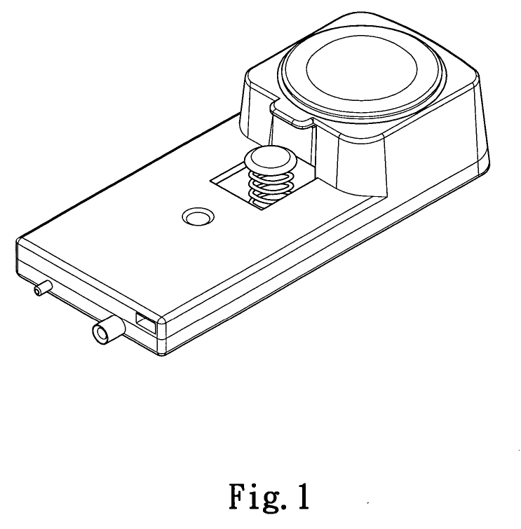

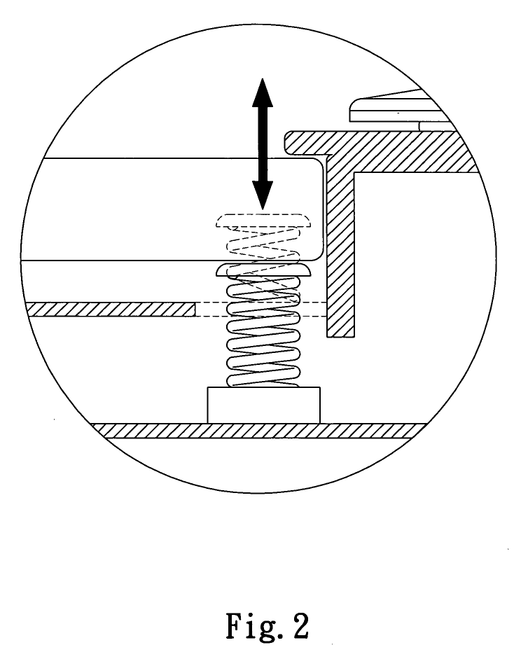

Please refer to FIG. 1 that is an assembled perspective view of a speaker with elastic fixing device according to a first embodiment of the present invention, and to FIG. 2 that is a fragmentary and enlarged sectional view showing the assembling of the present invention to a screen of a computer. For the purpose of conciseness, the present invention is also briefly referred to as “the speaker” throughout the Specification. In the first embodiment, the speaker is generally denoted with a reference numeral 1. As shown, the speaker 1 mainly includes a cabinet 10 for receiving tweeter, squawker, woofer, etc. therein. A first and a second stopper 11, 12 are provided at one lateral side of the cabinet 10 to extend from a rear and a front edge, respectively, of the lateral side.

As can be more clearly seen from FIG. 2, the first and the second stopper 11, 12 together define a clamping space 13 between them, and an elastic fixing device 20 is provided inside the first stopper 11 to normally elastically project from the first stopper 11 via an opening 11 formed on the first stopper 11 corresponding to the elastic fixing device 20.

The elastic fixing device 20 includes an elastic element holder 21, an elastic element 22, which is a spring in the first embodiment of the present invention and has an end fixedly connected to the elastic element holder 21, and a buffer 23 connected to an opposite end of the elastic element 22 and normally pushed forward by the elastic element 22 to project from the opening 111 into the clamping space 13 to contact with a main body of an electronic apparatus, to which the speaker 1 is assembled. The buffer 23 is provided around an upper end with a rounded guiding edge 231.

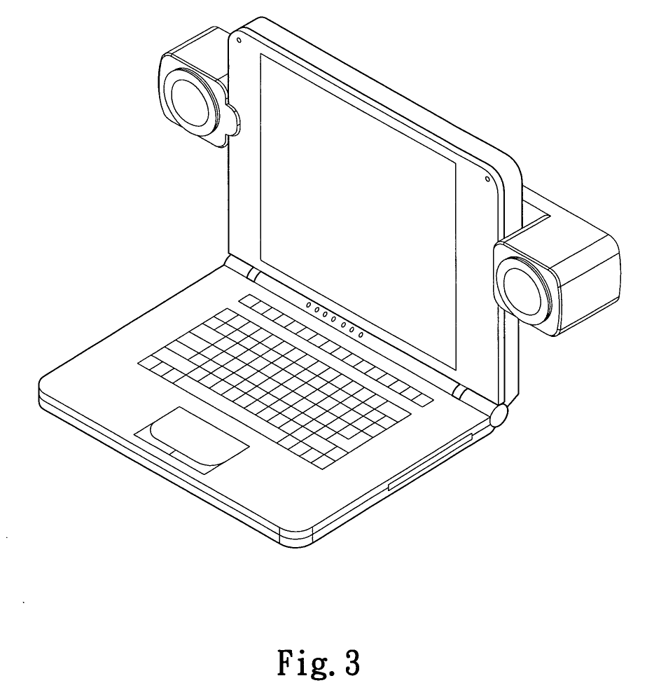

Please refer to FIG. 2. To assemble the speaker 1 to a main body of an electronic apparatus, such as a screen 30 of a notebook computer illustrated in FIG. 3, first orient the speaker received in the cabinet 10 toward a user, and then approach the clamping space 13 at one side of the cabinet 10 to one lateral side of the screen 30. The screen 30 is guided by the rounded guiding edge 231 of the buffer 23 to move into the clamping space 13, and the buffer 23 is pushed by a spring force of the elastic element 22 against the screen 30 for the same to firmly abut on the second stopper 12, so that the cabinet 10 is fixedly assembled to the screen 30.

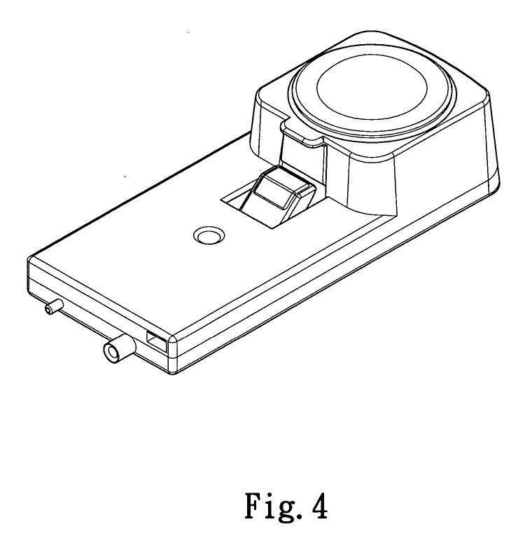

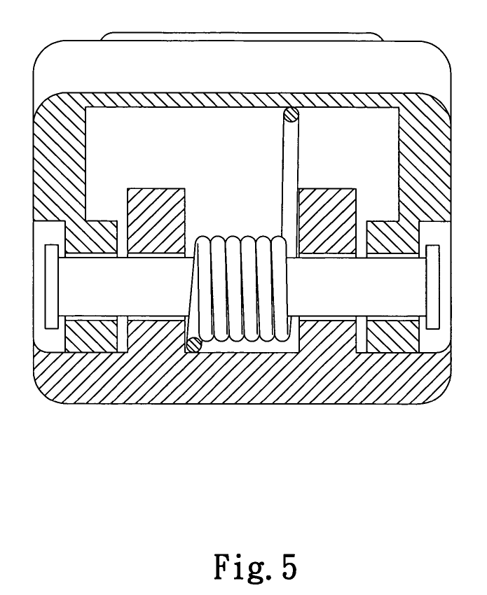

Please refer to FIG. 4 that is an assembled perspective view of a speaker with elastic fixing device according to a second embodiment of the present invention, and to FIG. 5 that is an enlarged sectional view of the elastic fixing device included in the speaker of FIG. 4. The speaker 1 in the second embodiment is generally structurally similar to the first embodiment except for the elastic fixing device thereof. Parts that are common to the first and the second embodiment are denoted with the same reference numerals. The elastic fixing device in the second embodiment is generally denoted with a reference numeral 20, and includes an elastic element holder 21, which includes a base 211 and a shaft 212 mounted on the base 211, and a spring 22 mounted around the shaft 212 with two ends pressed against the base 211 and a buffer 23, respectively. The buffer 23 is formed at one side with an inclined guiding surface 231.

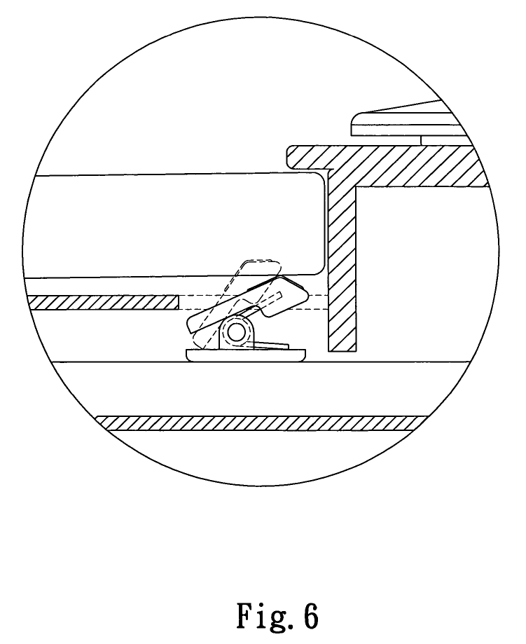

Please refer to FIG. 6. The speaker 1 according to the second embodiment of the present invention can be assembled to a screen 30 of a computer in the same manner as assembling the speaker of the first embodiment. When the speaker 1 of the second embodiment is approached to the screen 30, the screen 30 is guided by the inclined guiding surface 231 of the buffer 23 to move into the clamping space 13, and the buffer 23 is pushed by a spring force of the spring 22 against the screen 30 for the same to firmly abut on the second stopper 12, so that the cabinet 10 is fixedly assembled to the screen 30.

With the above arrangements, the speaker of the present invention could be externally mounted on a computer screen at two lateral sides thereof in a very convenient manner without occupying extra space. Moreover, the speaker assembled to the computer screen is oriented toward the user to provide stereo and high fidelity sound effect.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A speaker with elastic fixing device, comprising:
a cabinet for receiving tweeter, squawker, and woofer, etc. therein; said cabinet being provided at a rear and a front edge of one lateral side with a first and a second stopper, respectively, and said first and second stoppers being extended from said lateral side of said cabinet by a predetermined distance, respectively, to together define a clamping space therebetween, and
an elastic fixing device being provided inside said first stopper to normally elastically project from said first stopper via an opening formed on said first stopper corresponding to said elastic fixing device;
whereby when said cabinet is approached to an electronic apparatus for a lateral part of a main body of said electronic apparatus to move into said clamping space, said main body of said electronic apparatus is pushed by said elastic fixing device against said second stopper, allowing said cabinet to fixedly assemble to said electronic apparatus.

2. The speaker with elastic fixing device as claimed in claim 1, wherein said elastic fixing device includes an elastic element holder, an elastic element having an end fixedly connected to said elastic element holder, and a buffer connected to an opposite end of said elastic element to be normally pushed by said elastic element to contact with said main body of said electronic apparatus.

3. The speaker with elastic fixing device as claimed in claim 2, wherein said elastic element is a spring.

4. The speaker with elastic fixing device as claimed in claim 2, wherein said elastic element holder includes a base and a shaft fixedly mounted on said base; and said elastic element being mounted around said shaft with two ends pressed against said base and said buffer, respectively.

5. The speaker with elastic fixing device as claimed in claim 2, wherein said buffer has one side formed into an inclined guiding surface, at where said buffer is in contact with said electronic apparatus.
